(19) United States
(12) Patent Application Publication
(10) Pub. No.: US 2008/0154910 A1
(43) Pub. Date: Jun. 26, 2008

(54) Professional Contact Information Provider and Networking Tool

(75) Inventor: Horace James Caulkins, Chappaqua, NY (US)

Correspondence Address: HJCV, LLC, 24 CREST ROAD, CHAPPAQUA, NY, 10514, US

(73) Assignee: HJCV LLC, CHAPPAQUA, NY (US)

(21) Appl. No.: 11/616,208

(22) Filed: Dec. 26, 2006

(51) Int. Cl. G06F 17/30

(52) U.S. Cl. 707/10; 707/E17.032

(57) ABSTRACT

The invention is a computer-network based mechanism and interface which can be used by professionals to provide to personal and professional contacts their most up-to-date contact information; and secondarily, systems to facilitate upkeep of business relationships as well as to catalyze the making of new ones. The invention provides a user with space on a remote server (accessible via the World Wide Web) to store their professional and personal contact information (‘provider vehicle’). A user can then serve to other users (accessing the remote server via the World Wide Web) the content he/she has uploaded to the remote server, by providing them with pre-determined access rights (‘viewer vehicle’). The invention stores in the user's allotted remote server space, a record of the “viewer vehicles” and “provider vehicles” that have been served to that user by other users of the system. The invention also allows the user to manually amend information to this record and have it saved on the user's allotted memory on the remote server.

In addition, the invention provides a method for a user to be reminded at a user-defined interval to upkeep a professional or personal relationship. The invention provides a mechanism for users to append information to the “viewer vehicles” with which they are served and store the information on their allotted space on the remote serve. Finally, the invention includes a system (‘network builder’) which aggregates information which users have entered into a ‘network builder’ system, finds similarities, and then serves users notice of potential professionally or personally useful contacts.

### TECHNICAL FIELD AND APPLICABILITY OF THE INVENTION

The invention is a computer-network based mechanism and interface which can be used by professionals to provide to personal and professional contacts their most up-to-date contact information; and secondarily, systems to facilitate upkeep of business relationships as well as to catalyze the making of new ones. The invention provides a user with space on a remote server (accessible via the World Wide Web) to store their professional and personal contact information (‘provider vehicle’). A user can then serve to other users (accessing the remote server via the World Wide Web) the content he/she has uploaded to the remote server, by providing them with pre-determined access rights (‘viewer vehicle’). The invention stores in the user's allotted remote server space, a record of the “viewer vehicles” and “provider vehicles” that have been served to that user by other users of the system. The invention also allows the user to manually amend information to this record and have it saved on the user's allotted memory on the remote server.

In addition, the invention provides a method for a user to be reminded at a user-defined interval to upkeep a professional or personal relationship. The invention provides a mechanism for users to append information to the “viewer vehicles” with which they are served and store the information on their allotted space on the remote serve. Finally, the invention includes a system (‘network builder’) which aggregates information which users have entered into a ‘network builder’ system, finds similarities, and then serves users notice of potential professionally or personally useful contacts.

### BACKGROUND OF THE INVENTION

The invention provides professionals with a tool to serve to their contacts and clients their current professional and business contact information. This is done via the use of a remote server system in conjunction with the World Wide Web which uses a ‘provider vehicle’ defined by the user, and a ‘viewer vehicle’ customized by the user. The invention is the process by which a user assigns to a group of clients or contacts a customized ‘viewer vehicle.’ In addition, the invention includes the method by which this ‘viewer vehicle’ then allows clients and contacts (in conjunction with a user defined ‘provider vehicle’) to be provided with the user's current professional and business contact information.

### PRIOR ART

In the prior art, all mechanisms for providing professional and business contact information to clients and contacts have depended in some form on electronic mail for confirmation, notification, interaction and synchronization; and have required the maintenance of some amount of software or information on a personal computer for access, functionality or maintenance.

PlanetAll© (now owned by Amazon.com) is a main example of this previous art. One shortcoming of PlanetAll© and similar networked professional contact management systems (PeopleStreet, Contact.com) is that they require a symmetric membership contingent, meaning that for one user to have accurate information on another user, the second user must also be a subscriber to the service.

To target and improve on this, Plaxo© devised an interface which relies on an e-mail based mechanism to circumvent this membership symmetry issue. Plaxo© also relies on the downloading of software or some form of information by an individual onto their personal computer. This then provides them with an interface to update, keep or access online an address book on their personal computer, and update and coordinate the address book with other contacts via an electronic mail mechanism. However, Plaxo©'s model's incorporation of both downloaded software and reliance on electronic mail left room for improvement.

LinkedIn© and similar interfaces further improved on the issue of software downloading. They eliminated the reliance on downloaded software by moving much of this system to memory on a remote server accessible by users via a personal computer and the World Wide Web. However, these systems still require the use of electronic mail as the essential mechanism for user interaction, updating and confirmation in the prior art. This e-mail based updating and confirmation mechanism is a defining characteristic of the previous art.

All of the prior art depends on the downloading of some form of software to a personal computer for complete functionality, or on the use a mechanism such as e-mail, or a combination of both (GoodContacts.com). The invention herein, however, (1) does not use or rely on an e-mail mechanism for confirmation, synchronization, updating or any maintenance at all, (2) eliminates the need to download any software or information to provide an interface with the invention, and (3) does not require symmetric membership for complete information.

The invention herein provides a mechanism for the user to serve to clients and contacts up-to-date professional contact information without reliance on an e-mail confirmation, synchronization and notification mechanism. Specifically, this mechanism is the use of a user defined “viewer vehicle” and a user customized “provider vehicle.” In addition, the invention does not rely on the downloading and use of any software or information for access, upkeep or functionality, except for a vehicle to access the World Wide Web.

### SUMMARY OF THE INVENTION

The invention is a computer-network based mechanism and interface which can be used by professionals to provide to personal and professional contacts their most up-to-date contact information; and secondarily, systems to facilitate upkeep of business relationships as well as to catalyze the making of new ones. The invention provides a user with space on a remote server (accessible via the World Wide Web) to store their professional and personal contact information (‘provider vehicle’). A user can then serve to other users (accessing the remote server via the World Wide Web) the content he/she has uploaded to the remote server, by providing them with pre-determined access rights (‘viewer vehicle’). The invention stores in the user's allotted remote server space, a record of the “viewer vehicles” and “provider vehicles” that have been served to that user by other users of the system. The invention also allows the user to manually amend information to this record and have it saved on the user's allotted memory on the remote server.

In addition, the invention provides a method for a user to be reminded at a user-defined interval to upkeep a professional or personal relationship. The invention provides a mechanism for users to append information to the “viewer vehicles” with which they are served and store the information on their allotted space on the remote serve. Finally, the invention includes a system (‘network builder’) which aggregates information which users have entered into a ‘network builder’ system, finds similarities, and then serves users notice of potential professionally or personally useful contacts.

### DETAILED DESCRIPTION OF THE INVENTION

The invention is a computer-network based mechanism and interface which can be used by professionals to provide to personal and professional contacts their most up-to-date contact information; and secondarily to facilitate upkeep of business relationships as well as to catalyze the making of new ones.

“Provider vehicle”—The invention provides a user with space on a remote server (accessible via the World Wide Web) to store their professional and personal contact information (‘provider vehicle’). This “provider vehicle” is a segment of memory on the remote server which is allocated to the user for he/she to enter and store the information which he/she wishes to be able to serve to clients and contacts in the future. This user defined memory segment can be edited, changed and updated by the user at anytime when he/she has access to the remote server via the World Wide Web.

“Viewer vehicle”—A user can then serve to other users (accessing the remote server via the World Wide Web) the content he/she has stored on the remote server, by providing them with a “viewer vehicle.” The “viewer vehicle” is a set of user defined access rights. A user can configure a “viewer vehicle” to allow access to certain segments of the “provider vehicle” stored information. The user can provide his/her clients with a “viewer vehicle.” This “viewer vehicle,” in conjunction with the “provider vehicle” is the means by which a user is able to serve his/her contacts with up-to-date information.

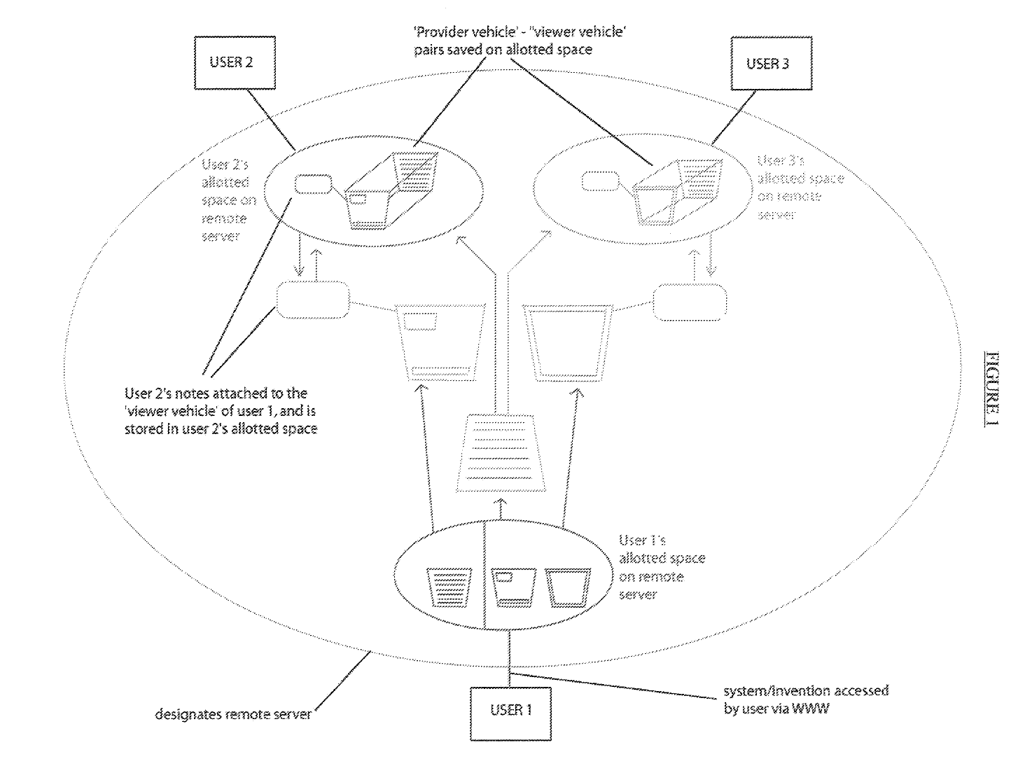

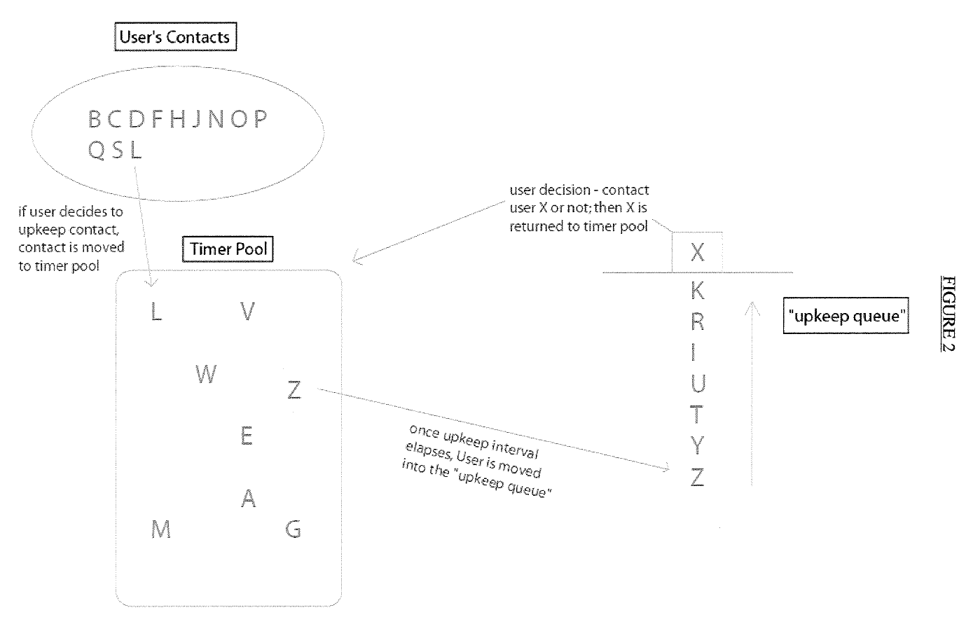

Through the coupling of the “provider vehicle” and the “viewer vehicle” a user provides up-to-date information via the remote server to his/her contacts. In summary, the user (user α) saves his/her contact information in allotted memory on the remote server accessible via the World Wide Web. On this remote server, user α also configures and stores his/her “viewer vehicles,” or customized access rights templates. User α then chooses other users to whom he/she would like to serve the “viewer vehicle.” The other users now have associated with their memory allotment on the remote server, the “viewer vehicle” given to them by user α, as well as the filtered information from user α's “provider vehicle.” When one of the other users accesses the remote server via the World Wide Web, they are served with user α's information via the “viewer vehicle” that was given to them, and user α's “provider vehicle” that is stored in the other users' allotted memory on the remote server. User α can revoke or modify the “viewer vehicles” which he/she has given out at any time, and can modify the information on his/her “provider vehicle.” The invention relies strictly on the “provider vehicle” and “viewer vehicle” interaction stored in users' memory allotments on the remote server, and access to this server via the World Wide Web. (FIG. 1)

Users also have the ability to manually amend information to the record of “provider vehicle” and “viewer vehicle” interaction stored in users' memory allotments on the remote server, and then to access this information via a personal computer and the World Wide Web.

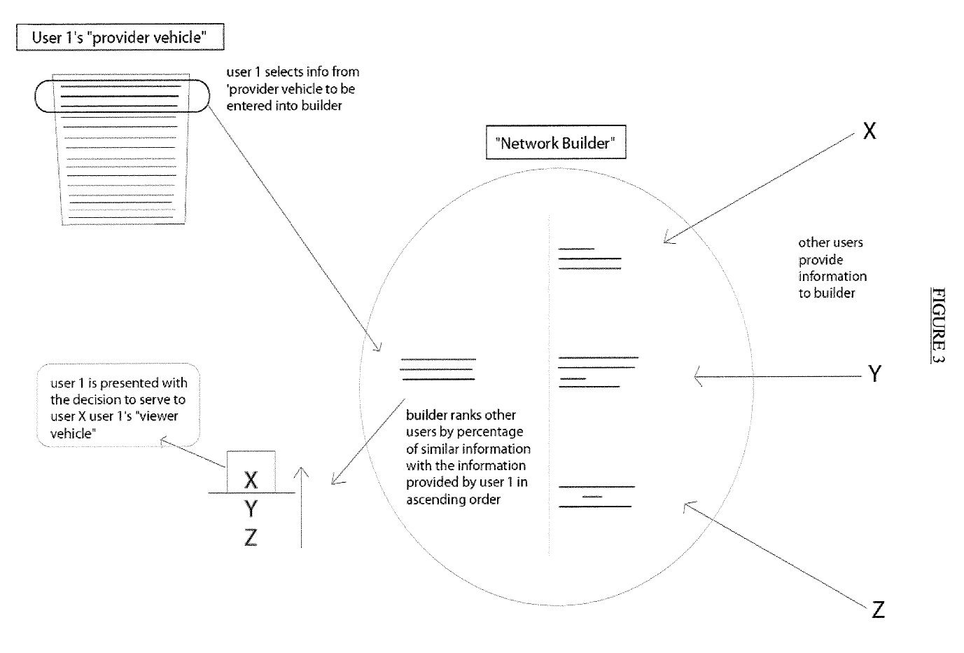

In addition, the invention provides a method for a user to be reminded at a user-defined interval to upkeep a professional or personal relationship (FIG. 2). In this system a user (user 1) can assign a time interval (“upkeep interval”) to another user (user 2). This information is stored on the space allotted to user 1 on the remote server. This time interval specifies the time from when user 1 specifies the time interval, until user 2 is placed into user 1's “upkeep queue.” The “upkeep queue” refers to a chronological list of other users stored on the space allotted to user 1 on the remote server. When user 2 becomes the first in user 1's “upkeep queue,” user 1 is notified on accessing the remote server, and can decide whether or not to contact user 2. After this decision, user 2 is removed from user 1's “upkeep queue” and is added back into the “upkeep queue” only after the specified time interval (“upkeep interval”) elapses again. This information is accessible only by user 1 via the World Wide Web.

The invention provides the ability for a user to attach to “viewer vehicles” which he/she is served bundles of information which will be stored in association with the “viewer vehicles” he/she has been given on his/her allotted space on the remote server. In addition, whenever the user accesses the remote server, and is served with the “viewer vehicles” that he/she has been given, he/she is also served with these associated bundles of information. These bundles remain in tact even if the “viewer vehicles” that the user is served with are modified. (FIG. 1)

Finally, the invention includes a system (“network builder”) which aggregates information that users have entered into the “network builder” system, finds similarities, and then serves users notice of potential professionally or personally useful contacts. In this system, the user enters certain professional and personal information into a database on the remote server. The system then scours the database and compares this information from the user (user A), with other information entered into the database by other users. The method then ranks other users who have entered information into the system by a similarity rating relative to user A's provided information (overall percentage of provided information similar or percentage of ‘fields’ with similarities). The highest ranked other user (user B) is then displayed to user A upon accessing the remote server via the World Wide Web, and user A is provided with the ability to serve to user B a “viewer vehicle.” This information is stored on user A's allotted space on the remote server, and can only be accessed by user A via the World Wide Web and the remote server.

A professional contact information provider and networking tool, including:

What is claimed for:

1. A system maintained on a remote server accessed by personal computers via the World Wide Web. The system consists of a compilation of users' ‘provider vehicles’ and ‘viewer vehicles.’ In this system a ‘provider vehicle’ consists of user-provided professional and personal contact information; a ‘viewer vehicle’ is a privacy filter configured by a user and served to other users. Each user has an allotted amount of memory, or “space,” on a remote server where his/her “provider vehicle” and “viewer vehicles” are stored.

2. A system such as the one described in claim 1, in which a user can customize the ‘viewer vehicle’ or filter, and serve this ‘viewer vehicle’ to a certain group of contacts, thereby allowing that group of contacts filtered access to the user's ‘provider vehicle.’

3. A system such as the one described in claim 3, in which a user's ‘provider vehicle’ can consist of professional and personal user defined contact information; the ‘provider vehicle’ can then be served to other system users when associated with a user assigned ‘viewer vehicle.’

4. A system such as the one in claim 3, in which the remote server maintains in its memory a record for each user of ‘provider vehicles’ and ‘viewer vehicles’ assigned to that user which the user can access via the World Wide Web.

5. A system such as the one in claim 4, in which a user can manually add information to the record detailed, and have this information stored in that user's allotted memory on a remote server accessible via the World Wide Web.

6. A system such as the one described in claim 4, in which a method is provided for a user to be reminded at a certain user-defined interval to contact an individual, and maintain a relationship.

7. A system such as the one described in claim 6, in which a user (user 1) can designate a time interval (‘upkeep interval’) to another user (user 2). This time interval specifies the time from when user 1 specifies the time interval, until user 2 is placed into user 1's ‘upkeep queue.’ When user 2 becomes the first in user 1's ‘upkeep queue’, user 1 can decide whether or not to contact user 2. After this decision, user 2 is removed from user 1's ‘upkeep queue’ and is added back into the ‘upkeep queue’ only after the specified time interval elapses. This information is stored in user 1's allotted memory on the remote server, and accessible only by user 1 via the World Wide Web.

8. A system such as the one described in claim 4, in which a method is provided by which a user enters certain information into a database of information provided by other users. The system then finds similarities between the user's information and that provided by other users and then poses to the user the ability to serve a ‘viewer vehicle’ to another user with whom the database has found significant similarity.

9. A system such as the one described in claim 8, in which the user enters certain professional and personal information into a database, the database then compares this information from the user (user A), with other information entered into the database by other users. The method then ranks other users who have entered information into the database by a similarity rating relative to user A's provided information (overall percentage of provided information similar or percentage of ‘fields’ with similarities). The highest ranked other user (user B) is then displayed to user A, and user A is provided with the ability to serve to user B a ‘viewer vehicle.’ This information would be stored in user A's space on the remote server, and accessible only by user A via the World Wide Web.

10. A system such as the one described in claim 4, in which a user (user X) can customize a ‘viewer vehicle’ and serve it to a group of other users in conjunction with user X's ‘provider vehicle.’ One of these of users, (user Y) can then attach a bundle of user Y defined information to the ‘viewer vehicle’ which user X has served to him/her. This information is stored on user Y's allotted memory on the remote server, and accessible only by user Y via the World Wide Web.

11. A system such as the one described in claim 4, in which the remote server maintains a record for each user of the other users' who have served him/her, or who he/she has been served with both a ‘provider vehicle’ and a ‘viewer vehicle.’ Each user can access this record via the World Wide Web. In addition, the system provides the user with a method for maintaining and updating this record outside of the remote server system.

12. A system, such as the one described in claim 11, in which the method for maintaining and updating this record outside of the remote server system is through the uploading and downloading of data from the remote server to a personal computer via the World Wide Web. The method allows the updating of this record outside of remote server system, and the ability of the user to upload these modifications to the record on the remote server system.
